(19) United States
(12) Patent Application Publication
(10) Pub. No.: US 2023/0334919 A1
(43) Pub. Date: Oct. 19, 2023

(54) ACOUSTIC DIAGNOSTICS OF VEHICLES

(71) Applicant: V2M Inc., Brooklyn, NY (US)

(72) Inventor: Petr BAKULOV, BRICK, NY (US)

(21) Appl. No.: 18/122,391

(22) Filed: Mar. 16, 2023

Related U.S. Application Data
(60) Provisional application No. 63/321,164, filed on Mar. 18, 2022.

(51) Int. Cl. H04R 1/40; G01M 17/007; G07C 5/08; H04R 3/00

(52) U.S. Cl. CPC G07C 5/0808; G01M 17/007; G07C 5/0825; H04R 1/406; H04R 3/005; H04R 2201/401; H04R 2499/13

(57) ABSTRACT

An acoustic diagnostics is proposed, which detects malfunction in any type of vehicles. At least three acoustic sensors are placed on the vehicle body; they are connected to a control unit. The controls unit software processes the signals coming from the sensors. The proposed technical solution provides real-time diagnostics of the most important moving elements of the vehicle structure: engine structural elements; power transmission details: bearings, axle shafts, hinges; attachments - generator, air conditioning compressor, starter, power steering pump; rollers - idle and tension; suspension parts; actuators of the brake system and some other depending on the type of vehicle.

### FIELD OF INVENTION

The software and hardware complex is designed to collect and process sound streams perceived by acoustic sensors installed on the vehicle in order to diagnose moving elements. The processing is performed by a control unit with pre-installed special software.

The proposed technical solution provides real-time diagnostics of the most important moving elements of the vehicle structure (the list is not restrictive): engine structural elements; power transmission details: bearings, axle shafts, hinges; generator, air conditioning compressor, starter, power steering pump; idle and tension rollers; suspension parts; actuators of the brake system.

### BACKGROUND

The known methods of acoustics diagnostics require special equipment which is available only at the service stations (or laboratories), and it is limited to the diagnostics of the engines and not the whole car.

Some companies offer smartphone applications that can detect sounds in the car and provide some diagnostics, however this approach is quite unreliable.

The goal of this invention is to provide a reliable vehicle diagnostic based on the data from acoustic sensors, which includes analysis of the operation of all elements of the car, not just engine only.

### SUMMARY

The proposed complex includes at least three acoustic sensors, control unit and a connection kit (it may differ depending on the application).

Acoustic sensors should be placed taking into account the design features of the vehicle. Typically, sensors are positioned along the car body, however there could be some exceptions in order to adapt to a specific model.

At least one sensor is placed in the front part of the car on a fixed, not moving part, for example, the body, subframe, etc. At least one sensor is placed in the middle of the car, or slightly closer to the front or back of the car, again on a fixed, not moving part. At least one sensor is placed in the rear part of the car on a fixed, not moving part, for example, the body, subframe, etc. FIG. 1 shows the component layout.

The control unit which performs the signal processing to detect vehicle malfunction using a deep neural network You Only Hear Once (YOHO). Once the malfunction is detected, the control unit calculates a position of the failed elements inside the vehicle based on the time of the signal receiving by various microphones. The coordinates of the microphones are know as well as the construction of the vehicle and location of the different moving elements in it.

### BRIEF DESCRIPTION OF THE DRAWINGS

FIG. 1 shows positions of the sensor on the vehicle.

FIG. 1A shows that the sensors may be positioned at different angles to each other, not necessarily as shown on this FIG. 1 or FIG. 1A. FIG. 1A also shows the directivity of the microphones. Though, in the preferred embodiment, the microphones are omnidirectional, any types of microphones may be used. The directivity of each pair of microphones on each sensor is opposite, see 11A and 11B, 11C and 11D, 11E and 11F.

FIG. 2 shows a block diagram of the hardware.

FIG. 3 illustrates a forward pass of the YOHO algorithm.

### DETAILED DESCRIPTION OF THE PREFFERED EMBODIMENT

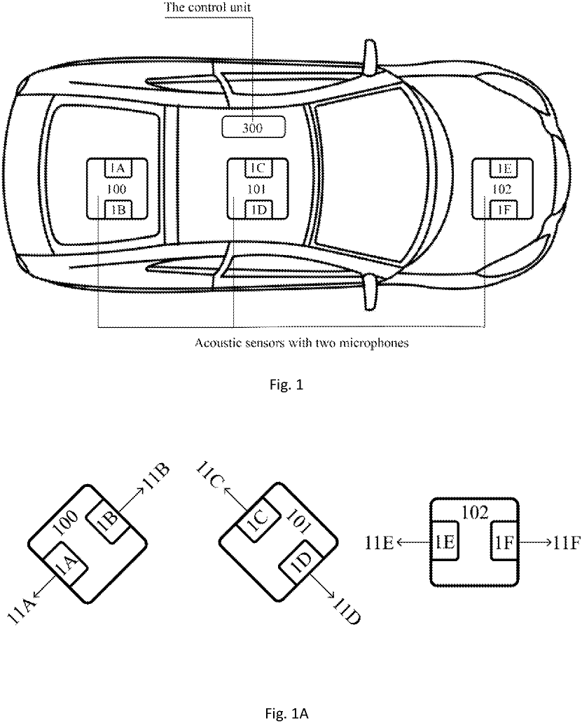

FIG. 1 shows the positions of the sensors and controls unit on the vehicle. The acoustic sensor uses at least two microphones, preferably based on MEMS (Micro-Electro-Mechanical Systems) technology. A MEMS microphone consists of two basic components: an integrated circuit (ASIC Application-Specific-Integrated Circuit) and a MEMS sensor. The integration of these components in a common housing is carried out using proprietary technologies from microphone manufacturers.

The control unit can be placed anywhere, in the preferred embodiment it is located in the glove compartment or in the trunk, being hidden in order to preserve the aesthetics of the interior.

The control unit that already on board the vehicle can be used as a control unit. However, it requires a hardware refinement of the unit by adding necessary inputs/outputs and boards / microcircuits.

The control unit is connected to sensors and external devices and is powered via its special cables.

Processing of audio signals is carried out in the frequency range at least from 80 Hz to 8 kHz.

The hardware complex is powered from the on-board network (battery) of the car.

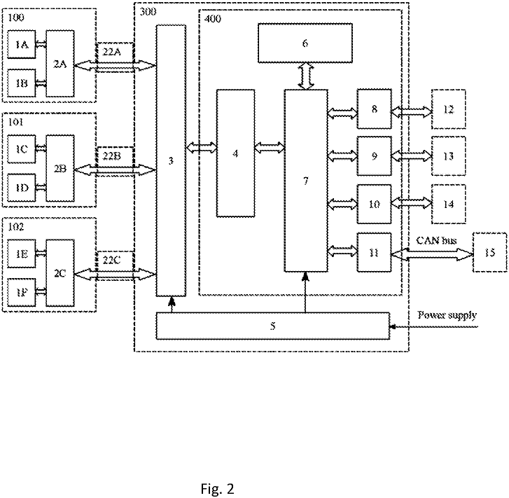

The block diagram of the hardware part of the system is shown in FIG. 2.

The dotted line highlights individual structural elements. 100, 101 and 102 indicate the acoustic sensors. Each sensor contains two boards of digital MEMS microphones and a board for an audio information input device. The sensor 100 has microphones 1A and 1B and the input device 2A. The sensor 101 has microphones 1C and 1D and the input device 2B. The sensor 102 has microphones 1E and 1F and the input device 2C.

Two microphones in the sensor are used to expand the coverage area and point in opposite directions.

Signals from two microphones are transmitted in one common PDM (Pulse Density Modulation) stream, one signal is latched on the rising edge of the PDM clock and the other is latched on the falling edge. The signals from the two microphones are further processed independently.

22A, 22B and 22C are connecting cables for the sound signal sensors and the processing unit.

The connection cables are based on a standard UTP cable (including four twisted pairs). One twisted pair carries the PDM clock signal from the processing unit to the sound sensor. The second twisted pair carries the PDM data signal from the sensor to the processing unit. The third and fourth twisted pairs are used to connect the sensor power supply. Both ends of the connecting cables have corresponding connectors. The length of the connecting cables depends on the location of the control unit relative to the sensors.

300 is the control unit which performs the signal processing. The processing unit is made in a single housing and contains an interface module board 3 on which level converters and signal converters are located, a power supply module board 5 to provide the necessary supply voltages for the sensors, and the main element is a processor board 400. The processor board includes a processor 7 with a built-in PDM controller 4, SSD 6, LTE modem 8, Wi-Fi module 9, navigation receiver 10 and CAN interface 11. 12, 13 and 14 are external antennas — LTE, Wi-Fi and navigation respectively.

In one embodiment the control unit is connected to the Central Processing Unit (15) through vehicle’s CAN bus.

The principle of operation is the following. The hardware complex receives audio signals arising from the vehicle units, converts them into electrical signals, transmits these electrical signals for processing by the complex software and with the ability to further transfer the results of processing on the CAN bus car to another control unit of the car for indication to the driver or without it, or to a remote server via a wireless data transfer.

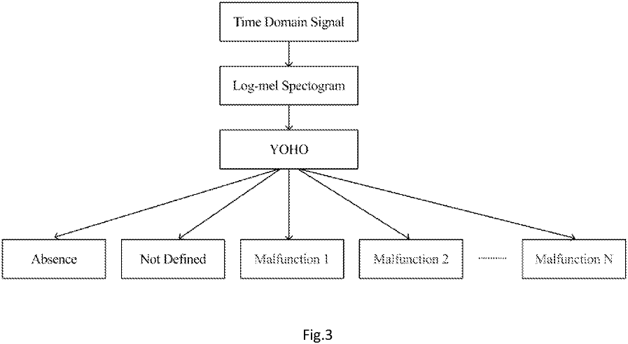

To increase the reliability of the system operation, each sensor has at least two microphones. The digitized acoustic signal is transmitted from the sensors to the control unit. The software of the electronic control unit uses a distributed neural network, being trained more than 2400 hours for diagnostics of sounds-symptoms of various malfunctions, and besides it includes an option of self-learning. The troubleshooting process is divided into two steps. First, the presence or absence of a malfunction is determined. The acoustic signals coming from the sensors are analyzed by the software in real time. In case of a possible malfunction, an additional test is performed. If the suspicious noise is does not disappear, the system makes an unambiguous conclusion about the presence of a vehicle malfunction, based on “Yes” or “No” principle shown in FIG. 3.

To detect vehicle malfunction a deep neural network You Only Hear Once (YOHO) is used, which is inspired by the YOLO algorithm popularly adopted in Computer Vision. It converts the detection of acoustic boundaries into a regression problem. One neuron detects the presence of an acoustic class. If the class is present, one neuron predicts the start point of the class and one neuron detects the end point of the class.

YOHO is purely a convolutional neural network (CNN). We use log-mel spectrograms as input features.

Because the problem a regression one, we used the sum squared error as loss function. Equation (1) shows the loss function for each acoustic class.

$$l o s s \left(\hat{y} , y\right) = \left\{\begin{matrix}{\left(\hat{y 1} - y 1\right)}^{2} + {\left(\hat{y 2} - y 2\right)}^{2} + {\left(\hat{y 3} - y 3\right)}^{2} , i f y 1 = 1 \\ {\left(\hat{y 1} - y 1\right)}^{2} , i f y 1 = 0\end{matrix}\right) \qquad \text{(1)}$$

where y and ŷ are the ground-truth and predictions respectively. y1 = 1 if the acoustic class is present and y1 = 0 if the class is absent. y2 and y3, which are the start and endpoints for each acoustic class are considered only if y1 = 1. In other words, (y^1- y1)² corresponds to the classification loss and (y^2 - y2)² + (y^3 - y3)² corresponds to the regression loss. The total loss L is summed across all acoustic classes. The loss function is used to optimize the model. It is a measure of discrepancy between true value of estimated parameter and prediction of neural network, it must be minimized by optimizer. YOHO decides which class a particular audio track belongs to, and the loss function serves as an estimate of the quality of the decision made, a kind of “approval”.

The network is trained with the Adam optimizer, a learning rate of 0.001, a batch size of 64. In some cases, L2 normalization is used, spatial dropout as regularization technics. Mix-up and SpecAugment are applied to augment data during training.

If the model detects a malfunction sound (class), then a time validation is performed. The fault class, its time start and time end are saved to the pickle file. If during the further exploitation of the machine the predicted malfunction sound appears four more times in a next four operation days (one time in one day), then it is confirmed that there is a mechanical malfunction in the car.

Secondly, the system determines of a faulty node. The speed of the acoustic wave (v) is estimated as 343 m/s. Since three sensors are installed on board the vehicle in different places (front and rear parts, middle of the car), each of the sensors will receive (“hear”) the same sound for the first time at different times. The position of a source of malfunction noise is determined, knowing the coordinates of the microphones, the exact time of sound reception and the speed of sound, by solving a system of equations of three equations.

To find the coordinates of the sound wave propagation source, four microphones are used (A, B, C, D respectively, which randomly chosen from our microphones 1A, 1B, 1C, 1D, 1E, 1F), and the source of the acoustic wave is point O.

If, at points A(0, 0), B(x_{b},y_{b}), C(x_{c},yc), D(x_{d},y_{d}), there are four microphones that receive an acoustic signal, the source of which is at the point O(x₀,y₀), then each sensor records the absolute time tₐ, t_{b}, t_{c}, t_{d} of signal reception on the corresponding microphones. These data have been obtained from measuring instruments on the sensors. It is possible to calculate the difference between the absolute times measured by the four sensor receivers using the following formulas:

$$\left\{\begin{matrix}{t}_{1} = {t}_{b} - {t}_{a} \\ {t}_{2} = {t}_{c} - {t}_{a} \\ {t}_{3} = {t}_{d} - {t}_{a}\end{matrix}\right) \qquad \text{(2)}$$

The equation of a circle with a center at point A(0, 0) is x² + y² = R², where R is the radius equal to the distance from point A(0, 0) to point O(x0,y0).

Next, the system of circles equations describing the dynamics of the acoustic wavefront propagation is developed with centers at points B, C and D so that the point O(x0, y0) also belongs to these circles:

$$\left\{\begin{matrix}{\left(x - {x}_{b}\right)}^{2} + {\left(y - {y}_{b}\right)}^{2} = {\left(R + v ∗ {t}_{1}\right)}^{2} \\ {\left(x - {x}_{c}\right)}^{2} + {\left(y - {y}_{c}\right)}^{2} = {\left(R + v ∗ {t}_{2}\right)}^{2} \\ {\left(x - {x}_{d}\right)}^{2} + {\left(y - {y}_{d}\right)}^{2} = {\left(R + v ∗ {t}_{3}\right)}^{2}\end{matrix}\right) \begin{matrix}\left(3\right) \\ \left(4\right) \\ \left(5\right)\end{matrix}$$

Using the equation (v - speed of the acoustic wave, speed of sound) of a circle with a center at point A, it is possible to reduce x² + y² on the left side and R² on the right in all three equations of the system. Subsequently, it is needed to multiply Equations (4) and (5) in the system by additional factors:

$$\left\{\begin{matrix}{x}_{b}^{2} + {y}_{b}^{2} = 2 R v {t}_{1} + {\left(v {t}_{1}\right)}^{2} - 2 \left(x ∗ {x}_{b} + y ∗ {y}_{b}\right) & \left(6\right) \\ \left({x}_{c}^{2} + {y}_{c}^{2}\right) \frac{{t}_{1}}{{t}_{2}} = 2 R v {t}_{1} + {t}_{1} {t}_{2} {v}^{2} - 2 \left(x ∗ {x}_{c} + y ∗ {y}_{c}\right) \frac{{t}_{1}}{{t}_{2}} & \left(7\right) \\ \left({x}_{d}^{2} + {y}_{d}^{2}\right) \frac{{t}_{1}}{{t}_{2}} = 2 R v {t}_{1} + {t}_{1} {t}_{3} {v}^{2} - 2 \left(x ∗ {x}_{d} + y ∗ {y}_{d}\right) \frac{{t}_{1}}{{t}_{2}} & \left(8\right)\end{matrix}\right)$$

As you can see, the system of three Equations (6) - (8) has three unknowns R, x, y. To solve this system, we subtract Equation (7) from Equation (8), and Equation (8) from Equation (6). Now, after the subtraction operations, we express the variables x and y for the source that is malfunctioning.

$$\left\{\begin{matrix}x = \frac{\frac{{x}_{b}^{2} + {y}_{b}^{2} - {\left(v {t}_{1}\right)}^{2}}{2} \left(\frac{1}{{y}_{b} - {y}_{d} \frac{{t}_{1}}{{t}_{2}}} - \frac{1}{{y}_{b} - {y}_{c} \frac{{t}_{1}}{{t}_{2}}}\right) + \frac{{v}^{2} {t}_{1} {t}_{3} - \left({x}_{d}^{2} \_ {y}_{d}^{2}\right) \frac{{t}_{1}}{{t}_{2}}}{2 \left({y}_{b} - {y}_{d} \frac{{t}_{1}}{{t}_{2}}\right)} + \frac{{v}^{2} {t}_{1} {t}_{2} - \left({x}_{c}^{2} + {y}_{c}^{2}\right) \frac{{t}_{1}}{{t}_{2}}}{2 \left({y}_{b} - {y}_{c} \frac{{t}_{1}}{{t}_{2}}\right)}}{\frac{{x}_{b} - {x}_{d} \frac{{t}_{1}}{{t}_{3}}}{{y}_{b} - {y}_{d} \frac{{t}_{1}}{{t}_{2}}} - \frac{{x}_{b} - {x}_{c} \frac{{t}_{1}}{{t}_{2}}}{{y}_{b} - {y}_{c} \frac{{t}_{1}}{{t}_{2}}}} \\ y = \frac{\frac{{x}_{b}^{2} + {y}_{b}^{2} - {\left(v {t}_{1}\right)}^{2}}{2} \left(\frac{1}{{x}_{b} - {x}_{d} \frac{{t}_{1}}{{t}_{3}}} - \frac{1}{{x}_{b} - {x}_{c} \frac{{t}_{1}}{{t}_{2}}}\right) + \frac{{v}^{2} {t}_{1} {t}_{3} - \left({x}_{d}^{2} + {y}_{d}^{2}\right) \frac{{t}_{1}}{{t}_{3}}}{2 \left({x}_{b} - {x}_{d} \frac{{t}_{1}}{{t}_{3}}\right)} + \frac{{v}^{2} {t}_{1} {t}_{2} - \left({x}_{c}^{2} + {y}_{c}^{2}\right) \frac{{t}_{1}}{{t}_{2}}}{2 \left({x}_{b} - {x}_{c} \frac{{t}_{1}}{{t}_{2}}\right)}}{\frac{{y}_{b} - {y}_{d} \frac{{t}_{1}}{{t}_{3}}}{{x}_{b} - {x}_{d} \frac{{t}_{1}}{{t}_{3}}} - \frac{{y}_{b} - {y}_{c} \frac{{t}_{1}}{{t}_{2}}}{{x}_{b} - {x}_{c} \frac{{t}_{1}}{{t}_{2}}}}\end{matrix}\right)$$

As a result, we obtain the coordinates of the position of the sound source.

Thus, the coordinates of the malfunction sound source is determined. It was shown in multiple experiments that the location of the noise is determined with 5 -15 centimeters accuracy depending on the test conditions and taking into account the unequal conditions for the propagation of the acoustic wave, the presence of obstacles, extraneous sounds, the speed of the car, etc. The accuracy is good enough to identify the element of the car that is faulty. The malfunctioning element is determined knowing the 3D model of the car.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A system for an acoustic diagnostics of a vehicle, comprising:
at least three acoustic sensors, all sensors being connected to a control unit;
all sensors being placed on a vehicle body; a first sensor is on a front part of the body; a second sensor is on a middle part of the body, and a third sensor is on a rear part of the body;
each sensor has at least two microphones;
all microphones receive acoustic signals from various moving elements of the vehicle and the sensors send corresponding electric signals to the control unit; the electric signals from at least six microphones are processed independently in the control unit;
the control unit identifies a vehicle malfunction based on a processing result and calculates a location of a malfunction part and determines what is the malfunction part;
the control unit display the location of the malfunction part.

2. The system of claim 1, where the control unit uses neural network for the signal processing.

3. The system of claim 2, where the neural network is a You Only Hear Once (YOHO).

4. The system of claim 3, where the YOHO is purely a convolutional neural network (CNN).

5. The system of claim 3, where the YOHO uses log-mel spectrograms as input features.

6. The system of claim 3, where the YOHO converts the processing into a regression problem, where one neuron detects the presence of an acoustic class, and if the class is present, one neuron predicts a start point of the class, and one neuron detects an end point of the class.

7. The system of claim 6, where a loss function is used for the processing optimization, which shows a discrepancy between a true value of an estimated parameter and an estimated value provided by the neural network, and the loss function is minimized by an Adam optimizer, and wherein the loss function provides an “approval” of the neural network, wherein YOHO makes a decision which of the classes each audio signal belongs to, and the loss function serves as an estimate of a quality of the decision made.

8. The system of claim 7, wherein the loss function is
$$l o s s \left(\hat{y} , y\right) = \left\{\begin{matrix}{\left(\hat{y} 1 - y 1\right)}^{2} + {\left(\hat{y} 2 - y 2\right)}^{2} + {\left(\hat{y} 3 - y 3\right)}^{2} , i f y 1 = 1 \\ {\left(\hat{y} 1 - y 1\right)}^{2} , i f y 1 = 0\end{matrix}\right)$$
where y and ŷ are the ground-truth and predictions respectively; y1 = 1 if the acoustic class is present and y1 = 0 if the class is absent; y2 and y3, which are the start and the endpoints for each acoustic class are considered only if y1 = 1.

9. The system of claim 2, wherein the neural network is a self-learning one.

10. The system of claim 1, wherein the microphones directivity in each sensor is directed in opposite directions.

11. The system of claim 1, wherein the microphones are omnidirectional ones.

12. The system of claim 1, wherein the location of the malfunction element is calculated based on known location of at least four microphones, the time of the acoustic signal arrival to each microphone and a known location of the moving elements in the vehicle.

13. The system of claim 1, wherein the location of the malfunction element is determined as
$$\left\{\begin{matrix}x = \frac{\frac{{x}_{b}^{2} + {y}_{b}^{2} - {\left(v {t}_{1}\right)}^{2}}{2} \left(\frac{1}{{y}_{b} - {y}_{d} \frac{{t}_{1}}{{t}_{3}}} - \frac{1}{{y}_{b} - {y}_{c} \frac{{t}_{1}}{{t}_{2}}}\right) + \frac{{v}^{2} {t}_{1} {t}_{3} - \left({x}_{d}^{2} + {y}_{d}^{2}\right) \frac{{t}_{1}}{{t}_{3}}}{2 \left({y}_{b} - {y}_{d} \frac{{t}_{1}}{{t}_{3}}\right)} + \frac{{v}^{2} {t}_{1} {t}_{2} - \left({x}_{c}^{2} + {y}_{c}^{2}\right) \frac{{t}_{1}}{{t}_{2}}}{2 \left({y}_{b} - {y}_{c} \frac{{t}_{1}}{{t}_{2}}\right)}}{\frac{{x}_{b} - {x}_{d} \frac{{t}_{1}}{{t}_{3}}}{{y}_{b} - {y}_{d} \frac{{t}_{1}}{{t}_{3}}} - \frac{{x}_{b} - {x}_{c} \frac{{t}_{1}}{{t}_{2}}}{{y}_{b} - {y}_{c} \frac{{t}_{1}}{{t}_{2}}}} \\ y = \frac{\frac{{x}_{b}^{2} + {y}_{b}^{2} - {\left(v {t}_{1}\right)}^{2}}{2} \left(\frac{1}{{x}_{b} - {x}_{d} \frac{{t}_{1}}{{t}_{3}}} - \frac{1}{{x}_{b} - {x}_{c} \frac{{t}_{1}}{{t}_{2}}}\right) + \frac{{v}^{2} {t}_{1} {t}_{3} - \left({x}_{d}^{2} + {y}_{d}^{2}\right) \frac{{t}_{1}}{{t}_{3}}}{2 \left({x}_{b} - {x}_{d} \frac{{t}_{1}}{{t}_{3}}\right)} + \frac{{v}^{2} {t}_{1} {t}_{2} - \left({x}_{c}^{2} + {y}_{c}^{2}\right) \frac{{t}_{1}}{{t}_{2}}}{2 \left({x}_{b} - {x}_{c} \frac{{t}_{1}}{{t}_{2}}\right)}}{\frac{{y}_{b} - {y}_{d} \frac{{t}_{1}}{{t}_{3}}}{{x}_{b} - {x}_{d} \frac{{t}_{1}}{{t}_{3}}} - \frac{{y}_{b} - {y}_{c} \frac{{t}_{1}}{{t}_{2}}}{{x}_{b} - {x}_{c} \frac{{t}_{1}}{{t}_{2}}}}\end{matrix}\right)$$
where v is a speed of an acoustic wave (speed of sound); A(0, 0), B(x_{b},y_{b}), C(x_{c},yc), D(x_{d},y_{d}) are coordinates of four microphones A, B, C, D; tₐ, t_{b}, t_{c}, t_{d} are times of the acoustic signal reception; t₁=t_{b}-tₐ; t₂=t_{c}-tₐ; t₃=t_{d}-tₐ.
